(19) United States
(12) Patent Application Publication
(10) Pub. No.: US 2004/0054804 A1
(43) Pub. Date: Mar. 18, 2004

(54) System and method for failure recovery of high-speed modems

(76) Inventor: Chuang Li, Saratoga, CA (US)

Correspondence Address: FISH & NEAVE, 1251 AVENUE OF THE AMERICAS, 50TH FLOOR, NEW YORK, NY, 10020-1105, US

(21) Appl. No.: 10/234,544

(22) Filed: Aug. 30, 2002

(51) Int. Cl. G06F 15/16; G06F 15/173

(52) U.S. Cl. 709/239; 709/218; 714/4

(57) ABSTRACT

A system and method for providing uninterrupted Internet access to users in a local area network is described. The system and method provide failure recovery of a high-speed modem through dial-up modem access without requiring additional hardware in the router. The system and method enable the router to automatically switch from a high-speed modem to a dial-up modem so that the switch is transparent to all the users in the local area network.

### FIELD OF THE INVENTION

This invention relates generally to a system and method for providing uninterrupted Internet access using high-speed modems. More specifically, the present invention provides a system and method for failure recovery of high-speed modems.

### BACKGROUND OF THE INVENTION

The popularity of the Internet has grown rapidly over the past several years. A decade ago, the Internet was limited to the academic and research community. Today, the Internet has grown into a communications network that reaches millions of people around the world. It provides a powerful and versatile environment for business, education, and entertainment. Millions of people worldwide access the Internet daily for communicating, retrieving information, shopping, and exploiting various other services. The increasing use of the Internet combined with the large number of services provided have created a virtually insatiable demand for faster, cheaper, and reliable, around-the-clock Internet access.

Traditional Internet access has involved two options. First, Internet access is provided with the use of a computer with a direct connection to the Internet backbone. In this case, bandwidths of up to 100 Mbps are achieved, but at the cost of a very expensive infrastructure usually deployed only at large academic, governmental, and business institutions. Second, a very low cost solution to Internet access is provided with the use of a computer equipped with a dial-up modem that connects to the Internet backbone through existing telephone lines. While this solution has vastly popularized Internet use among home users, its low bandwidth of only up to 56 Kbps for V.90 dial-up modems makes it impractical and frustrating for users to access a variety of Internet services requiring high transmission rates, especially multimedia intensive applications involving video and audio streaming.

To address the need for fast and reliable Internet access at an affordable price, a new set of technologies has recently been developed. Users can now choose between high-speed Internet connections provided by T1 or T3 lines leased from telephone companies, cable modems, or DSL modems.

The first option can carry data at a rate of up to 1.5 Mbps, roughly 60 times more than a normal residential modem, and requires a point-to-point dedicated physical connection between the user's computer and the telephone company's switch. This option provides uninterrupted Internet access as a result of using the reliable TCP/IP protocol to carry data through the Internet backbone, which consists of in numerous routers that can be used in case any one of the routers or other network equipment fails. However, Ti lines are still prohibitively expensive and not widely available to the average Internet user.

Alternatively, the second and third options provide relatively inexpensive and high bandwidth Internet access. Users may access the Internet by connecting a high-speed cable modem to an existing cable line or by connecting a high-speed DSL modem to an existing phone line. The cable modem may be integrated with a TV set-top box or it may be a standalone device that is internal or external to a computer. A typical cable modem connection achieves bandwidths of anywhere from 3 to 50 Mbps, while a typical DSL connection achieves rates of 640 Kbps downstream (from the Internet to the user's computer) and 128 Kbps upstream (from the user's computer to the Internet), with the actual bandwidth depending on the distance from the user's computer to the telephone company's central office (the longer the distance, the slower the connection).

Besides a cable or DSL modem, all the other infrastructure required for high speed Internet access is provided by the cable or telephone company and is therefore transparent to the user. The only costs incurred by the user to have a much higher bandwidth connection to the Internet as compared to using a standard dial-up modem connection are the installation costs of the high speed modem and the service fees charged by the cable or DSL service provider.

In addition, a single Internet connection can be shared by multiple machines in a local area network (“LAN”) by using a router coupled with the high speed modem. The router handles all the traffic distribution from the cable or phone line to each one of the computers in the LAN. The router may be integrated with the modem in a single device or connected externally to the modem and each one of the computers in the LAN. This configuration is especially attractive to home users or small business owners that have multiple machines and a high demand for fast Internet access.

However, the use of high-speed cable or DSL modems does not guarantee a reliable Internet connection. When the cable or DSL modem fails and the Internet connection is interrupted, the user is forced to wait for the modem to recover on its own or request technical support from the cable or DSL service provider to repair the modem before re-establishing the high-speed Internet access. Alternatively, the user may connect to the Internet using the dial-up modem that is typically embedded in his/her computer, thereby suffering a significant drop in bandwidth and time delays often incurred with dial-up Internet access. And in case the user is connected to a cable or DSL modem through a router in a LAN configuration, only one computer in the LAN will be able to switch to dial-up modem service through a single phone line.

To address the need for fast, around-the-clock Internet access, backup technologies for high-speed modems have been developed. The backup technologies provide an alternative Internet connection via a dial-up modem for all users in the LAN in case the high-speed modem connection fails. In a typical scenario, the router handles switching to an integrated V.90 or ISDN backup connection in the event of high-speed modem failure.

These backup technologies require the router to be equipped with additional software as well additional DAA circuitry to implement the backup connection. The router also requires an internal V.90 modem, a V.90 module slot, or a serial port for connectivity with a standalone V.90 modem. Examples include the R6131 router sold by Netopia, Inc., of Alameda, Calif., and the FriendlyNET™ FR3004C router sold by Asante Technologies, Inc., of San Jose, Calif.

Although enabling all users in a LAN to have uninterrupted Internet access, these backup technologies are complex to configure, expensive, and require significant software and hardware changes to the router infrastructure. In addition, the extra hardware in the router may add more points of potential network failure.

In view of the foregoing drawbacks, it would be desirable to provide a system and method for failure recovery of a high-speed modem that do not require additional hardware.

It also would be desirable to provide a system and method for failure recovery of a high-speed modem that do not require significant software and hardware changes in the router connected to the modem.

### SUMMARY OF THE INVENTION

In view of the foregoing, it is an object of the present invention to provide a system and method for failure recovery of a high-speed modem that do not require additional hardware.

It is also an object of the present invention to provide a system and method for failure recovery of a high-speed modem that do not require significant software and hardware changes in the router connected to the modem.

These and other objects of the present invention are accomplished by providing a system and method for failure recovery of a high-speed modem that is connected through a router to various Internet appliances. The Internet appliances are electronic devices configured with an Internet access system such as personal and portable computers, electronic organizers, personal digital assistants (“PDAs”), and wireless telephones, among others.

The failure recovery is accomplished by using one of the Internet appliances connected to the router as a gateway with a dial-up connection and directing all the other Internet appliances to the gateway. This way, when the high-speed modem fails, Internet access is guaranteed by a single dial-up connection on the gateway that is shared by all the Internet appliances connected to the router. The router is not required to have additional hardware, and simply routes the Internet packets from/to the other Internet appliances to the gateway.

In a preferred embodiment, the system of the present invention involves four main software components: (1) a modem interchange software module resident on the router; (2) a modem backup software module resident on an Internet appliance connected to the router so that the Internet appliance can act as a gateway; (3) an Internet Connection Sharing (“ICS”) software module resident on the gateway; and (4) a communications protocol between the router and the gateway.

The modem interchange software module resident on the router handles the switch from the high-speed modem to a dial-up modem that may be a standalone device connected to the gateway or integrated into the gateway. The modem interchange software module detects the high-speed modem failure and communicates the failure to the modem backup software module on the gateway using the communications protocol.

The modem backup software module launches the ICS software module on the gateway so that all the other Internet appliances connected to the router can maintain their Internet connection. The ICS software module is a software module that shares a single IP address with all the other Internet appliances connected on the LAN through the router. The router then routes all the other Internet appliances to the gateway so that the ICS module on the gateway can provide Internet access capabilities to the Internet appliances through the dial-up modem.

When the high-speed modem service resumes, the modem interchange software module resident on the router communicates the service reactivation to the modem backup software module resident on the gateway using the communications protocol. The modem backup software module instructs the ICS software module to deactivate its shared connection and communicates the deactivation back to the router. The router then proceeds to resume the high-speed modem service to all the Internet appliances connected in the LAN.

Advantageously, the system and method of the present invention provide users on a LAN with around-the-clock Internet access without requiring additional hardware or significant changes to the LAN router. In addition, the system and method of the present invention enable the router to automatically switch from a high-speed modem to a dial-up modem so that the switch is transparent to all the users on the LAN.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic view of the system and the network environment in which the present invention operates;

FIG. 2 is a schematic view of the software components used in a preferred embodiment of the present invention;

FIG. 3 is an illustrative flowchart for activating a backup dial-up modem connection on the gateway in case of high-speed modem failure; and

FIG. 4 is an illustrative flowchart for reactivating a high-speed modem connection.

### DETAILED DESCRIPTION OF THE DRAWINGS

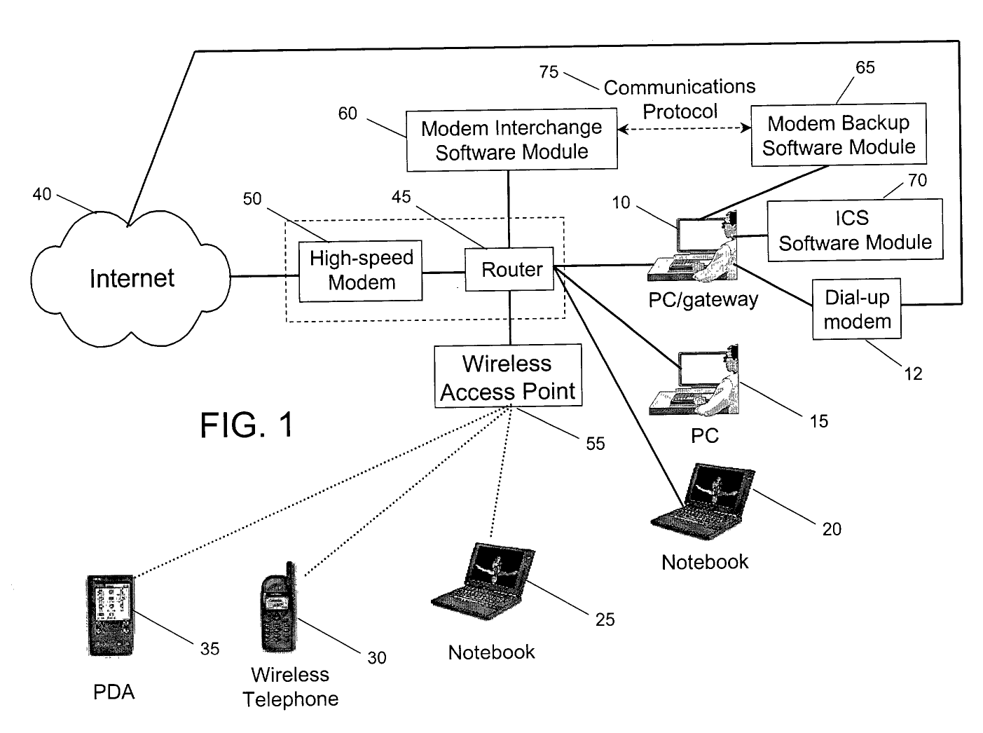

Referring now to FIG. 1, a schematic view of the system and the network environment in which the present invention operates is described. Internet appliances 10-35 connect to Internet 40 through router 45 via high-speed modem 50. Internet appliances 10-20 connect to router 45 through a wired connection, while Internet appliances 25-35 connect to router 45 by means of a wireless connection through wireless access point 55. High-speed modem 50 may be a DSL modem such as the external USB home DSL modem sold by Actiontec Electronics, Inc., of Sunnyvale, Calif., or a cable modem such as the Etherfast cable modem sold by Linksys, of Irvine, Calif.. It should be understood by one skilled in the art that router 45 may be a standalone device or integrated into high-speed modem 50.

Router 45 is equipped with modem interchange software module 60 to provide uninterrupted Internet access to Internet appliances 10-35. When high-speed modem 50 fails, modem interchange software module 60 detects that failure and activates dial-up modem 12 connected to Internet appliance 10. Internet appliances 10-35 then continue accessing the Internet without an interruption through router 45 and Internet appliance 10.

It should be understood by one skilled in the art that dial-up modem 12 can be a standalone dial-up modem external to Internet appliance 10 as shown in FIG. 1 or integrated into Internet appliance 10.

The dial-up modem connection is activated by modem backup software module 65 on Internet appliance 10. Modem backup software module 65 initiates a dial-up modem connection on Internet appliance 10 and launches ICS software module 70, so that Internet appliances 15-35 can share a single IP address with Internet appliance 10, which therefore functions as a gateway. When ICS software module 70 is activated, modem backup software module 65 communicates the activation to modem interchange software module 60 using communications protocol 75. Router 45 then routes all the packets from/to Internet appliances 15-35 to/from Internet 40 through gateway 10.

When high-speed modem 50 resumes normal operation, modem interchange software module 60 detects that change and communicates that status to modem backup software module 65. Modem backup software module 65 then instructs ICS software module 70 to deactivate its shared connection with Internet appliances 15-35 and notifies router 45 when the dial-up connection has been shut down. Router 45 then proceeds to resume the high-speed modem service to all of Internet appliances 10-35.

It should be understood by one skilled in the art that any or all of Internet appliances 10-35 may be equipped with ICS software module 70. In this case, router 45 may designate a default Internet appliance to act as a gateway, or it may instruct modem interchange software module 60 to decide which one of Internet appliances 10-35 will be selected to act as a gateway.

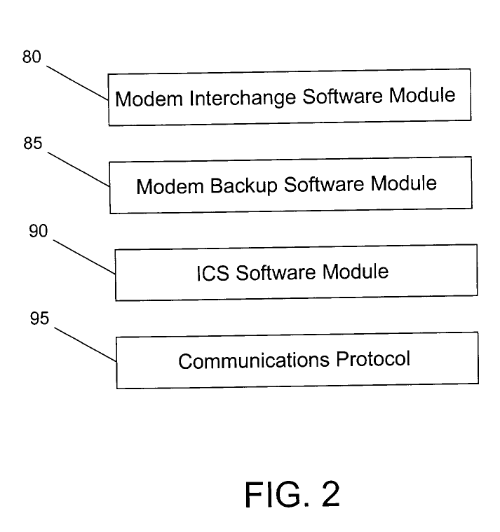

Referring now to FIG. 2, a schematic view of the software components used in a preferred embodiment of the present invention is described. The software components consist of: (1) modem interchange software module 80; (2) modem backup software module 85; (3) ICS software module 90; and (4) communications protocol 95.

Modem interchange software module 80 is a software module resident on router 45 responsible for handling the switch from high-speed modem 50 to dial-up modem 12 connected to gateway 10 when high-speed modem 50 fails. Modem interchange software module 80 detects the failure of high-speed modem 50 and communicates the failure to modem backup software module 85 on gateway 10 using communications protocol 95. Additionally, modem interchange software module 80 instructs router 45 to route packets from/to Internet appliances 15-35 to/from Internet 40 through gateway 10 when dial-up modem 12 is activated and to resume the high-speed connection to Internet 40 through high-speed modem 50 when high-speed modem 50 resumes normal operation. When this happens, modem interchange software module 80 also instructs modem backup software module 85 to deactivate ICS software module 90.

Modem backup software module 85 activates dial-up modem 12 connected to gateway 10 and launches ICS software module 90 so that Internet appliances 15-35 connected to router 45 can maintain their connection to Internet 40. Modem backup software module 85 also communicates the activation of ICS software module 90 to modem interchange software module 80 using communications protocol 95. Further, modem backup software module 85 instructs gateway 10 to stop running ICS software module 90 upon receiving notice from modem interchange software module 80 that high-speed modem 50 has resumed normal operation.

ICS software module 90 is a software module that shares a single IP address with all the other Internet appliances connected in the LAN through the router. When high-speed modem 50 fails, ICS software module 90 is launched by modem backup software module 85 to share gateway 10 connection to Internet 40 with Internet appliances 15-35. ICS software module 90 assigns IP addresses to Internet appliances 15-35 and maps the IP addresses into the single IP address assigned to gateway 10 by router 45.

Communications protocol 95 is a protocol between modem interchange software 80 and modem backup software module 85 for exchanging messages during the transition from high-speed modem 50 to dial-up modem service and vice-versa.

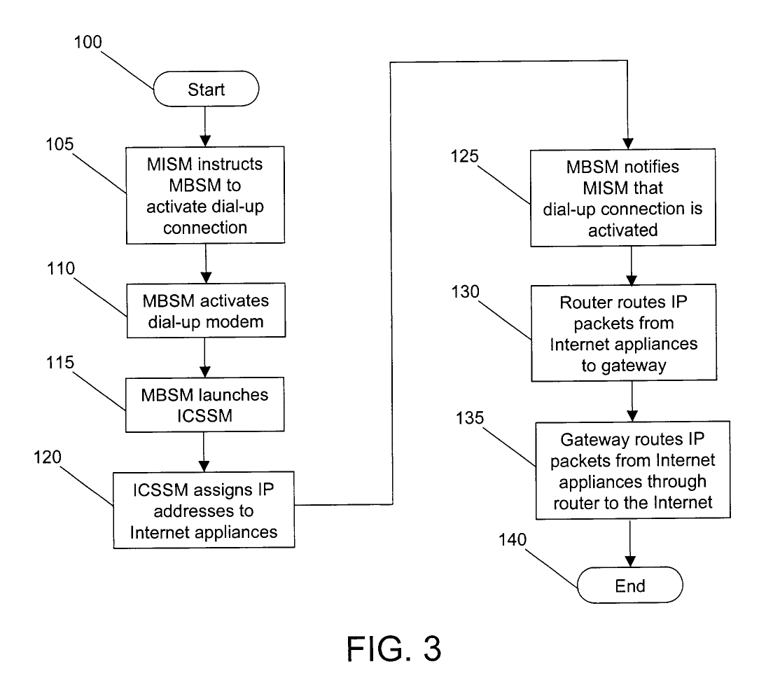

Referring now to FIG. 3, an illustrative flowchart for activating a backup dial-up modem connection on the gateway in case of high-speed modem failure is described. At step 105, modem interchange software module (“MISM”) 80 instructs modem backup software module (“MBSM”) 85 to activate the dial-up connection on gateway 10. At step 110, MBSM 85 activates dial-up modem 12 connected to gateway 10. Dial-up modem 12 may be a standalone device external to gateway 10 as shown in FIG. 1, or integrated into gateway 10.

At step 115, MBSM 85 launches ICS software module (“ICSSM”) 90 on gateway 10. At step 120, ICSSM 90 assigns IP addresses to Internet appliances 15-35 so that Internet appliances 15-35 can share the single IP address assigned to gateway 10 by router 45 to access the Internet with a slower dial-up connection when high-speed modem 50 fails. After ICSSM 90 is launched, MBSM 85 notifies MISM 80 at step 125 that the dial-up connection is activated.

At step 130, router 45 routes any IP packets from/to Internet appliances 15-35 to/from Internet 40 through gateway 10 and at step 135, gateway 10 routes any IP packets from Internet appliances 15-35 to Internet 40 through router 45.

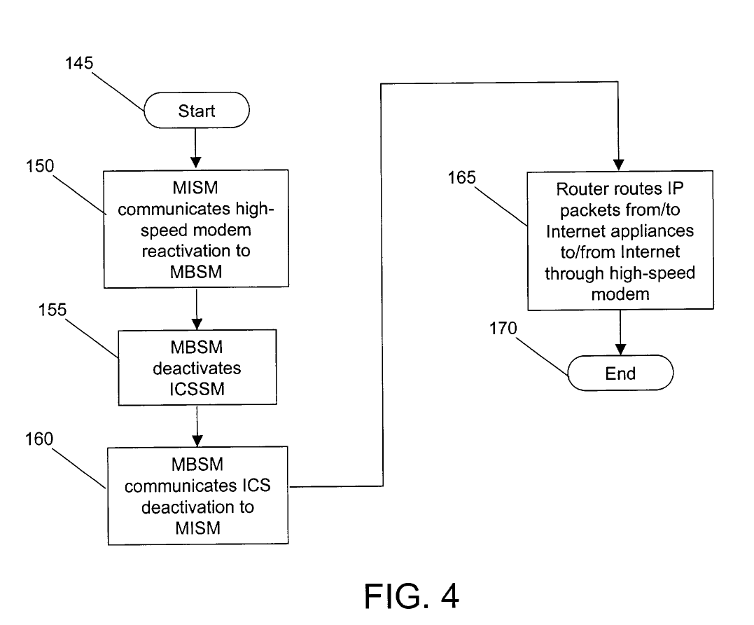

Referring now to FIG. 4, an illustrative flowchart for reactivating a high-speed modem connection is described. At step 150, MISM 80 communicates the high-speed service reactivation to MBSM 85 using communications protocol 95. MBSM 85 then instructs ICSSM 90 at step 155 to deactivate its shared dial-up connection and communicates the deactivation back to MISM at step 160.

At step 165, router 45 proceeds to resume the high-speed modem service to all of Internet appliances 10-35 by routing IP packets from/to Internet appliances 10-35 to/from Internet 40 through high-speed modem 50.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for providing uninterrupted Internet access to users connected in a local area network through a router, the method comprising:
providing high-speed Internet access through a high-speed modem connected to the router;
monitoring a status of the high-speed modem; and
launching a dial-up Internet connection application on a gateway in the local area network.

2. The method of claim 1, wherein the local area network comprises a plurality of Internet appliances.

3. The method of claim 2, wherein the plurality of Internet appliances comprise at least one of: a personal computer; a notebook computer; a wireless telephone; a personal digital assistant; and an entertainment system.

4. The method of claim 1, wherein the gateway comprises a dial-up modem.

5. The method of claim 1, wherein the gateway comprises an Internet appliance connected in the local area network.

6. The method of claim 1, wherein launching a dial-up Internet connection application comprises routing packets from the plurality of Internet appliances to the Internet through the gateway via the router when failure of the high-speed modem is detected.

7. The method of claim 1, wherein launching a dial-up Internet connection application comprises forwarding packets from the Internet to the plurality of Internet appliances through the gateway and routing the packets from the gateway through the router to the plurality of Internet appliances.

8. The method of claim 1, further comprising resuming high-speed Internet access when the high-speed modem is reactivated.

9. A system for providing uninterrupted Internet access to users connected in a local area network, the system comprising:
a plurality of Internet appliances connected to the Internet through a router;
a high-speed modem connected to the router;
a dial-up modem connected to a-gateway in the local area network, wherein the gateway comprises an Internet connection sharing routine;
a software routine in the router that monitors the status of the high-speed modem and activates the dial-up modem when the high-speed modem fails; and
a software routine in the gateway, responsive to the software routine in the router, that activates the Internet connection sharing routine when failure of the high-speed modem is detected.

10. The system of claim 9, wherein the gateway comprises one or more of the plurality of Internet appliances.

11. The system of claim 9, wherein the Internet appliances comprise at least one of: a personal computer; a notebook computer; a wireless telephone; a personal digital assistant; and an entertainment system.

12. The system of claim 9, wherein the software routine in the router comprises:
a routine for instructing the router to route packets through the gateway when failure of the high-speed modem is detected;
a routine for instructing the gateway to cease running the Internet connection sharing routine when the high-speed modem is reactivated; and
a routine for instructing the router to route packets through the high-speed modem when the high-speed modem is reactivated.

13. The system of claim 9, wherein the software routine in the gateway comprises:
a routine for activating the dial-up modem;
a routine for launching the Internet connection sharing routine;
a routine for communicating the dial-up modem activation to the router; and
a routine for instructing the gateway to cease running the Internet connection sharing routine when the high-speed modem is reactivated.

14. The system of claim 9, further comprising a communications protocol for communicating between the router and the gateway.

15. A system for automatically switching between high-speed Internet access and dial-up Internet access in a local area network, the system comprising:
a plurality of Internet appliances in the local area network;
a gateway comprising an Internet connection sharing routine; and
a router comprising a routine for activating the Internet connection sharing routine when the high-speed Internet access fails.

16. The system of claim 15, further comprising a high-speed modem connected to the router.

17. The system of claim 15, further comprising a dial-up modem.

18. The system of claim 15, wherein the gateway comprises a dial-up modem.

19. The system of claim 15, wherein the router comprises a dial-up modem and a high-speed modem.

20. The system of claim 15, wherein the routine for activating the Internet connection sharing routine comprises:
a routine for detecting failure in the high-speed modem;
a routine for communicating the failure to the gateway;
a routine for instructing the gateway to launch the Internet connection sharing routine;
a routine for instructing the router to route packets through the gateway when the high-speed modem fails;
a routine for instructing the gateway to stop running the Internet connection sharing routine when the high-speed modem is reactivated; and
a routine for instructing the router to route packets through the high-speed modem when the high-speed modem is reactivated.
